(19) United States
(12) Patent Application Publication
(10) Pub. No.: US 2019/0043479 A1
(43) Pub. Date: Feb. 7, 2019

(54) WAKE ON VOICE KEY PHRASE SEGMENTATION

(71) Applicant: INTEL CORPORATION, Santa Clara, CA (US)

(72) Inventors: Tomasz Dorau, Gdansk (PL); Tobias Bocklet, Munich (DE); Przemyslaw Tomaszewski, Reda (PL); Sebastian Czyryba, Mragowo (PL); Juliusz Norman Chojecki, Gdansk (PL)

(73) Assignee: INTEL CORPORATION, Santa Clara, CA (US)

(21) Appl. No.: 15/972,369

(22) Filed: May 7, 2018

(51) Int. Cl. G10L 15/04; G10L 15/16; G10L 15/02

(52) U.S. Cl. CPC G10L 15/04; G10L 2015/025; G10L 15/02; G10L 15/16

(57) ABSTRACT

Techniques are provided for segmentation of a key phrase. A methodology implementing the techniques according to an embodiment includes accumulating feature vectors extracted from time segments of an audio signal, and generating a set of acoustic scores based on those feature vectors. Each of the acoustic scores in the set represents a probability for a phonetic class associated with the time segments. The method further includes generating a progression of scored model state sequences, each of the scored model state sequences based on detection of phonetic units associated with a corresponding one of the sets of acoustic scores generated from the time segments of the audio signal. The method further includes analyzing the progression of scored state sequences to detect a pattern associated with the progression, and determining a starting and ending point for segmentation of the key phrase based on alignment of the detected pattern with an expected pattern.

### BACKGROUND

Key phrase detection is an important feature in voice-enabled devices. The device may be woken from a low-power listening state by the utterance of a specific key phrase from the user. The key phrase detection event initiates a human-to-device conversation, such as, for example, a command or question to a personal assistant. This conversation includes further processing of the user's speech, and the effectiveness of this processing depends, in large part, on the accuracy with which the boundaries of the key phrase within the audio signal are determined, a process referred to as key phrase segmentation. There remains, however, a number of non-trivial issues with respect to key phrase segmentation techniques.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts.

FIG. 1 is a top-level block diagram of a voice-enabled device, configured in accordance with certain embodiments of the present disclosure.

FIG. 2 is a block diagram of a key phrase detection and segmentation circuit, configured in accordance with certain embodiments of the present disclosure.

FIG. 3 is a block diagram of a Hidden Markov Model (HMM) key phrase scoring circuit, configured in accordance with certain embodiments of the present disclosure.

FIG. 4 illustrates an HMM state sequence, in accordance with certain embodiments of the present disclosure.

FIG. 5 illustrates a progression HMM state sequences, in accordance with certain embodiments of the present disclosure.

FIG. 6 is a block diagram of a key phrase segmentation circuit, configured in accordance with certain embodiments of the present disclosure.

FIG. 7 is a flow diagram illustrating an implementation of a start point calculation circuit, configured in accordance with certain embodiments of the present disclosure.

FIG. 8 is a flow diagram illustrating an implementation of an end point calculation circuit, configured in accordance with certain embodiments of the present disclosure.

FIG. 9 is a flowchart illustrating a methodology for key phrase segmentation, in accordance with certain embodiments of the present disclosure.

FIG. 10 is a block diagram schematically illustrating a voice-enabled device platform configured to perform key phrase segmentation, in accordance with certain embodiments of the present disclosure.

Although the following Detailed Description will proceed with reference being made to illustrative embodiments, many alternatives, modifications, and variations thereof will be apparent in light of this disclosure.

### DETAILED DESCRIPTION

As previously noted, there remains a number of non-trivial issues with respect to key phrase segmentation techniques in voice-enabled devices. For example, some existing key phrase segmentation techniques are based on voice activity detection which relies on changes in signal energy to determine start and stop points of speech. These techniques have limited accuracy, especially in noisy environments. Other approaches use simple speech classifiers that also fail to exploit a-priori knowledge of the expected key phrase and therefore tend to misclassify the speech, resulting in segmentation errors which can adversely affect the performance of the voice-enabled device.

Thus, this disclosure provides techniques for segmentation of a detected wake on voice key phrase from an audio stream in real-time, with improved accuracy. The detection of a key phrase may cause a voice-enabled device to be woken from a low-power listening state to a higher power processing state for recognition, understanding, and responding to the speech of the user. Accurate segmentation of the key phrase from the input audio signal (e.g., determining the start and stop times of the key phrase) is important for the reliable performance of these follow-on speech processing tasks, examples of which will be listed below. In an embodiment, the techniques are implemented in a voice-enabled device that employs a-priori knowledge of expected signal characteristics (the sequence of phonetic or sub-phonetic units that comprise the key phrase), which allows for enhanced discrimination of the key phrase from background signals and noise. In some such example embodiments, this is achieved through tracking of Hidden Markov Model (HMM) key phrase model scores for the expected pattern, and identification of the segment of the input audio signal that produces the matching score sequence, as will be described in greater detail below.

The disclosed techniques can be implemented, for example, in a computing system or a software product executable or otherwise controllable by such systems, although other embodiments will be apparent. The system or product is configured to perform key phrase segmentation for a voice-enabled device. In accordance with an embodiment, a methodology to implement these techniques includes accumulating feature vectors extracted from time segments of an audio signal. The method also includes implementing a neural network to generate a set of acoustic scores based on the accumulated feature vectors. Each of the acoustic scores in the set represents a probability for a phonetic class associated with the time segments. The method further includes implementing a key phrase model decoder to generate a progression of model state score sequences. Each of the scored model state sequences is based on detection of (sub-)phonetic units associated with a corresponding one of the sets of the acoustic scores generated from the time segments of the audio signal. The method further includes analyzing the progression of scored state sequences to detect a pattern associated with the progression, and determining a starting point and an ending point for segmentation of the key phrase based on an alignment of the detected pattern with an expected pattern.

As will be appreciated, the techniques described herein may allow for an improved user experience with a voice-enabled device, by providing more accurate segmentation of the wake on voice key phrase so that the performance of follow-on applications, such as, for example, acoustic beamforming, speech recognition, and speaker identification, is enhanced. Compared to existing segmentation methods which either rely on voice activity detection or employ more simplistic classifiers which do not exploit a-priori knowledge of the key phrase, the disclosed techniques provide more reliable key phrase segmentation.

The disclosed techniques can be implemented on a broad range of platforms including laptops, tablets, smart phones, workstations, video conferencing systems, gaming systems, smart home control systems, and low-power embedded DSP/CPU systems or devices. Additionally, in some embodiments, the data may be processed entirely on a local platform or portions of the processing may be offloaded to a remote platform (e.g., employing cloud based processing, or a cloud-based voice-enabled service or application that can be accessed by a user's various local computing systems). These techniques may further be implemented in hardware or software or a combination thereof.

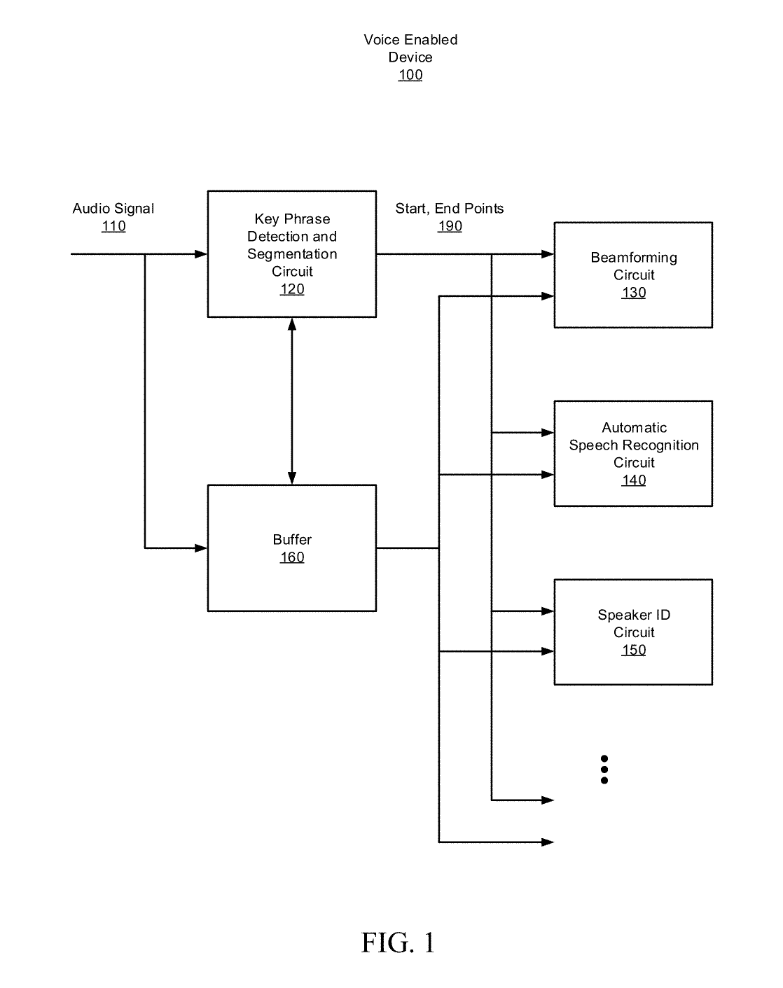

FIG. 1 is a top-level block diagram of a voice-enabled device 100, configured in accordance with certain embodiments of the present disclosure. The voice-enabled device 100 is shown to include a key phrase detection and segmentation circuit 120 configured to detect a wake on voice key phrase that may be present in the audio signal 110 containing speech from the user of the device, and to determine a starting point and an ending point of that key phrase. The operation of the key phrase detection and segmentation circuit 120 will be explained in greater detail below. Also shown is a buffer 160 that is configured to store a portion of the audio signal 110 for use by the key phrase detection and segmentation circuit 120. In some embodiments, the buffer may be configured to store between 2 and 5 seconds of audio, which should be sufficient to capture and store a typical key phrase which generally has a duration of between 600 milliseconds and 1.5 seconds. Additionally, a number of example follow-on speech processing applications are shown, including a beamforming circuit 130, an automatic speech recognition circuit 140, and a speaker ID circuit 150. These example applications may benefit from accurate segmentation of the key phrase from the audio signal 110, although many other such applications may be envisioned including text dependent speaker identification, emotion recognition, gender detection, age detection, and noise estimation. The start and end points 190 of the key phrase segmentation are provided to these applications along with access to the buffer 160 so that the applications can access the key phrase. In some embodiments, the buffer 160 may be configured to store feature vectors extracted from the audio signal (as will be described below) rather than the audio signal.

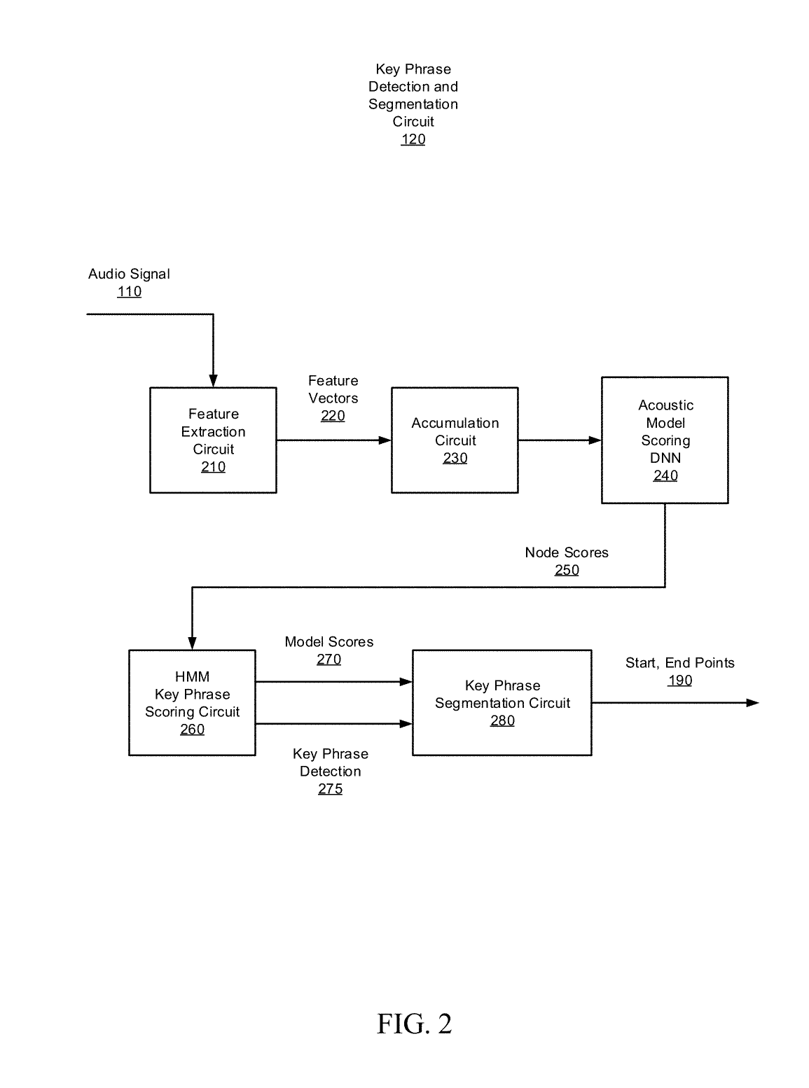

FIG. 2 is a block diagram of a key phrase detection and segmentation circuit 120, configured in accordance with certain embodiments of the present disclosure. The key phrase detection and segmentation circuit 120 is shown to include a feature extraction circuit 210, an accumulation circuit 230, an acoustic model scoring neural network 240, a Hidden Markov Model (HMM) key phrase scoring circuit 260, and a key phrase segmentation circuit 280. The key phrase detection and segmentation circuit 120 operates in an iterative fashion by processing blocks (e.g., time segments) of the provided audio signal 110 in each iteration, as will be described in greater detail below.

The feature extraction circuit 210 is configured to extract feature vectors 220 from the time segments of the audio signal 110. In some embodiments, the feature vectors may include any suitable feature vectors that are representative of acoustic properties of the speech which are of interest, and the feature vectors may be extracted using known techniques in light of the present disclosure. The accumulation circuit 230 is configured to accumulate a selected number of the extracted feature vectors from consecutive time segments to provide a sufficiently wide context for representation of the acoustic properties over a selected period of time. The number of features to be accumulated, as well as the duration of each time segment, may be determined heuristically. In some embodiments, one feature vector may be extracted from each time segment and 5 to 20 feature vectors may be accumulated which relate to 50 to 200 milliseconds of audio.

The acoustic model scoring neural network 240 is configured to generate a set of acoustic scores based on the accumulated feature vectors. Each of the acoustic scores in the set represents a probability for a phonetic class associated with the time segments. In some embodiments, the phonetic class can be a phonetic unit, a sub-phonetic unit, a tri-phone state (e.g., three consecutive phonemes) or a mono-phone state (e.g., one phoneme). The terms “phonetic unit” and “sub-phonetic unit” as used interchangeably herein for convenience, may be considered to include phonemes, phonetic units, and sub-phonetic units. Each acoustic score may be presented at an output node of the neural network. In some embodiments the acoustic model scoring neural network 240 is implemented as a Deep Neural Network (DNN), although its variants may be used as well, such as recurrent neural networks (RNNs) and convolutional neural networks (CNNs).

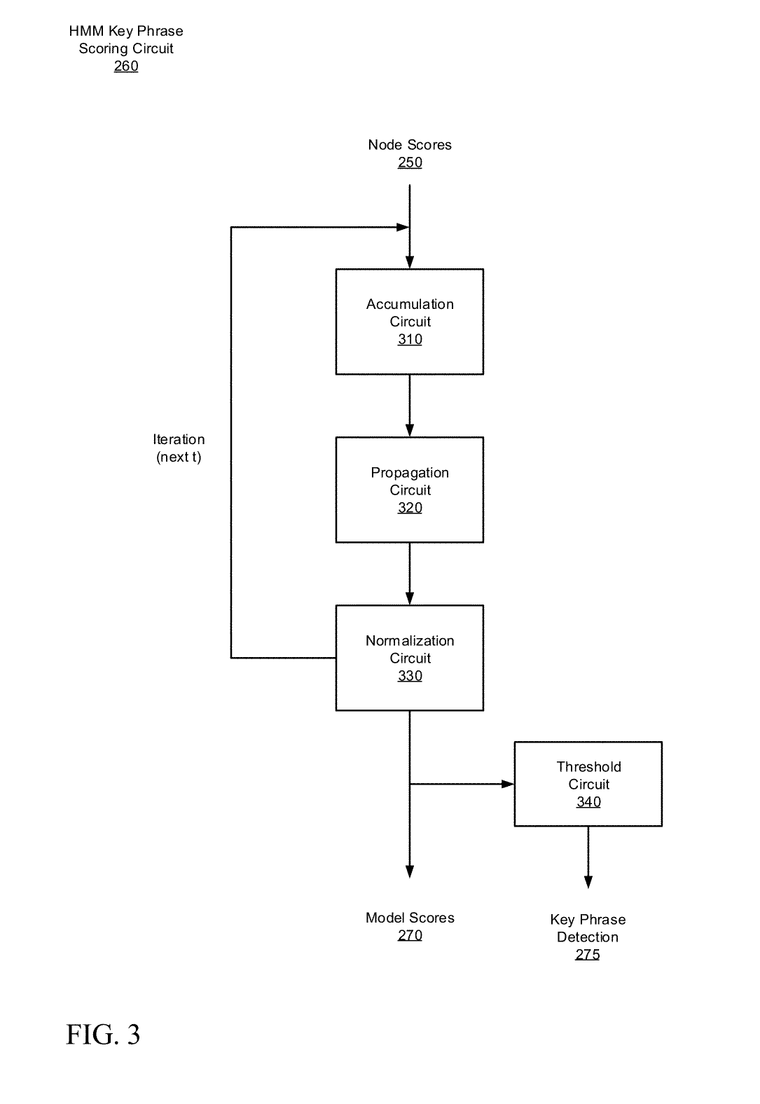

At a high level, the HMM key phrase scoring circuit 260 is configured to generate a progression of scored model state sequences. Each of the scored model state sequences is based on detection of (sub-)phonetic units associated with a corresponding one of the sets of the acoustic scores generated from the time segments of the audio signal. The HMM key phrase scoring circuit 260 is also configured to detect the key phrase based on an accumulation and propagation of the acoustic scores of the sets of the acoustic scores. The operation of the HMM key phrase scoring circuit 260 will be described in greater detail below in connection with FIG. 3.

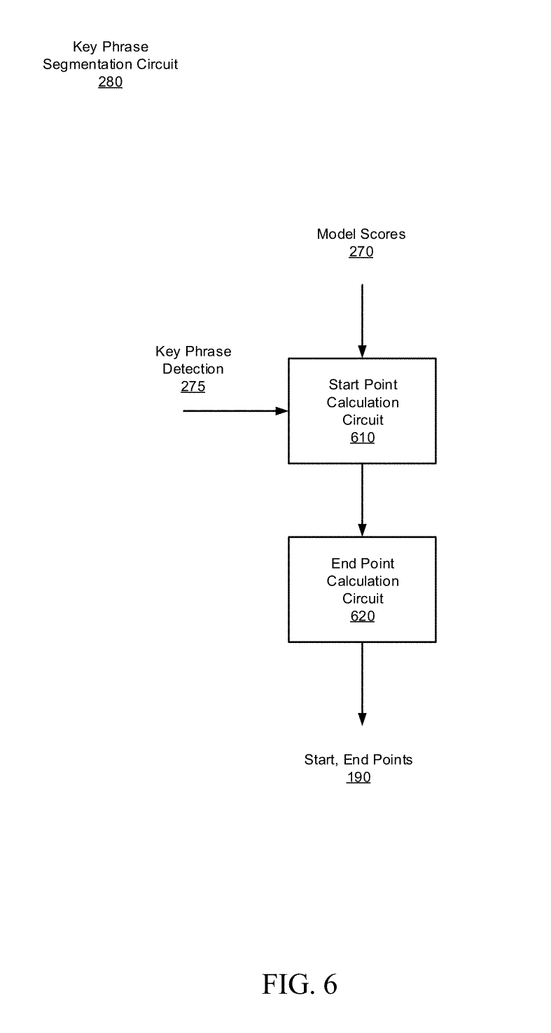

At a high level, the key phrase segmentation circuit 280 is configured to analyze the progression of scored state sequences to detect a pattern associated with the progression, and to determine a starting point and an ending point for segmentation of the key phrase based on an alignment of the detected pattern to an expected pattern and on the time segment associated with the key phrase detection provided by circuit 260. The operation of the key phrase segmentation circuit 280 will be described in greater detail below in connection with FIG. 6-8.

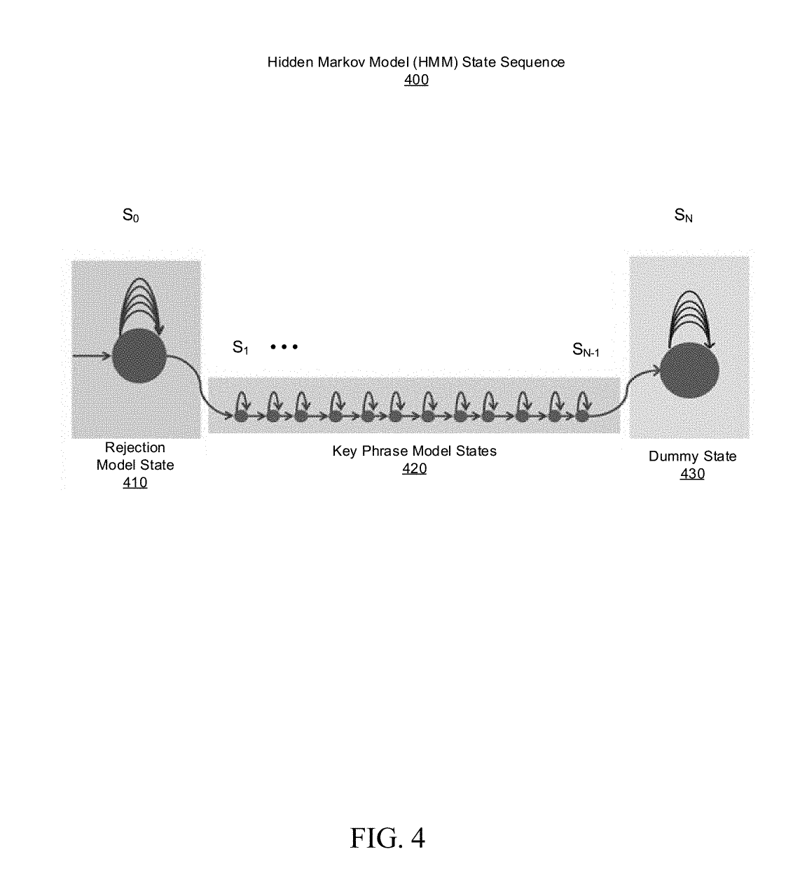

FIG. 3 is a block diagram of the HMM key phrase scoring circuit 260, configured in accordance with certain embodiments of the present disclosure. For each iteration, corresponding to a new time segment of the audio signal 110, the acoustic model scoring DNN 240 provides scores 250 at the output node of the DNN. Each node score 250, represents a probability associated with a phonetic unit. The HMM key phrase scoring circuit 260 implements an HMM state sequence (also referred to as a Markov chain) which corresponds to a sequence of (sub-)phonetic units forming the key phrase. This is illustrated in FIG. 4 which shows an HMM state sequence 400 comprising N+1 states, each state associated with a score {S₀ . . . S_{N}}. Each of the HMM states correspond to one or more of the DNN node scores 250. The initial HMM state 0 is the rejection model state 410. This state models everything that does not belong to the key phrase and it includes silence and rejection DNN node scores. The HMM states 1 N−1 form the key phrase model states sequences 420. Each of these states transitions corresponds to one DNN node score associated with a specific part of the key phrase (phonetic unit). In each iteration a new score for each HMM state is calculated, based on the HMM scores from previous iterations and the new corresponding DNN node scores, as will be explained below. The final score of the key phrase model is calculated as final score=S_{N+1}−S₀ and expresses a log likelihood that the key phrase was spoken.

In some embodiments, an optional additional N-th state, referred to as the dummy state 430, may be included to follow the key phrase model states 420. This dummy state models everything that comes after the key phrase and has a role similar to that of the rejection model in that it models everything which does not belong to the key phrase. It also corresponds to silence and rejection DNN node scores 250. The dummy state 430 serves to improve the reliability of the identification of the end of the key phrase and allows for the possibility of arbitrary speech or silence after the key phrase including a spoken command.

The HMM key phrase scoring circuit 260 is shown to include an accumulation circuit 310, a propagation circuit 320, a normalization circuit 330, and a threshold circuit 340.

The accumulation circuit 310 is configured to accumulate the DNN node scores 250 for each corresponding HMM state. For each key phrase model state 420, k=1 N, the score of corresponding DNN node is added to the state score Sₖ. For the rejection state 0 410 and the dummy state N 430, the maximum of all of the silence and rejection DNN node scores are added to the state scores S₀ and S_{N}.

The propagation circuit 320 is configured to propagate the accumulated state scores through the sequence. For each key phrase model state k=0 . . . , N−1, the associated score Sₖ is propagated forward if the next state score Sₖ+1 is lower than Sₖ. This can be expressed as: Sₖ+1<←Sₖ IF Sₖ>Sₖ+1. The operation is performed in the order of descending index k to avoid data dependency.

The normalization circuit 330 is configured to normalize the state scores by subtracting the maximum of the scores. This can be expressed as: Sₖ←Sₖ−Sₘₐₓ, where Sₘₐₓ=max{Sₖ: k=0 . . . N}.

The threshold circuit 340 is configured to compare the final score (final score=S_{N+1}−S₀, as described above) to a selected threshold value, and if the final score exceeds that threshold, to generate a key phrase detection event 275. The key phrase detection is associated with the current time segment of the audio signal 110 being processed for which this event occurs.

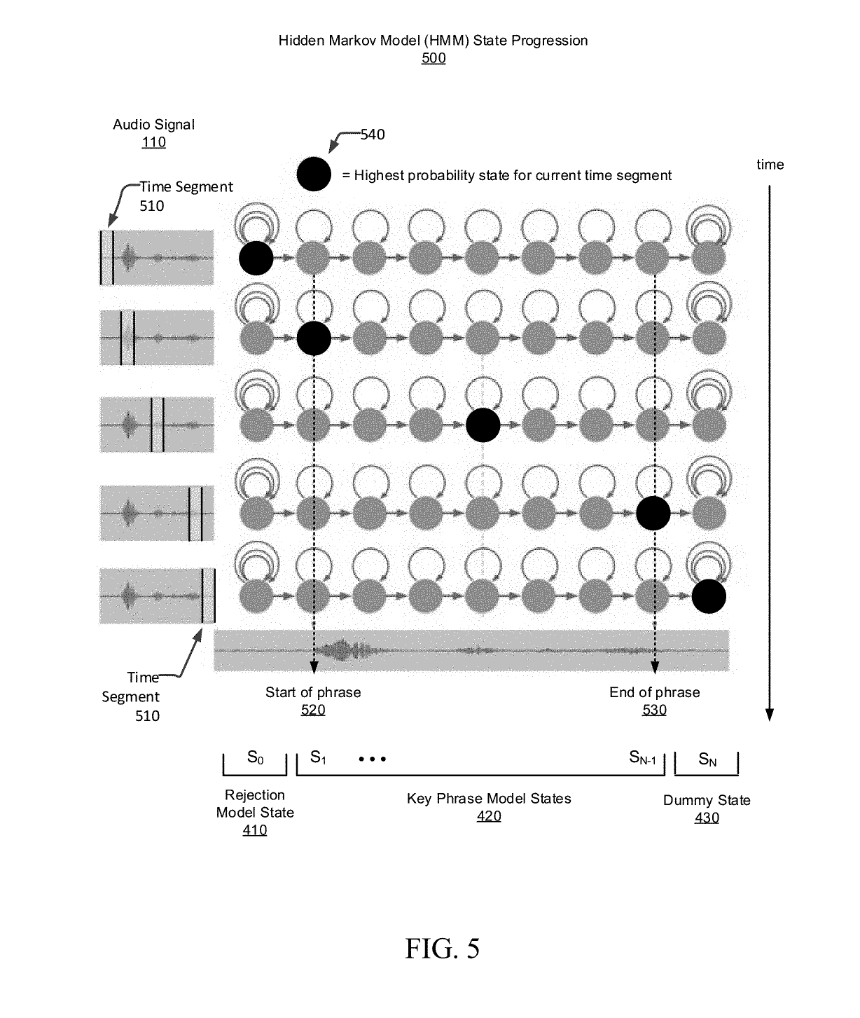

The disclosed segmentation process is based on an observed progression of MINI key phrase model state scores {S₀ . . . S_{N}}. FIG. 5 illustrates an example of this progression over time, in accordance with certain embodiments of the present disclosure. Each row depicts the results of processing of a different time segment 510 of the audio signal 110, with time increasing from top to bottom. The black filled circles 540 indicate the highest probability state for the current time segment. An analysis of the temporal evolution of the key phrase model state scores during processing of the detected key phrase shows that the progression generally matches a specific pattern. This fact can be exploited to recognize the pattern, align the pattern in time with the input audio signal, and identify the time segments that contain the key phrase.

As the audio signal 110 is being processed, but before the key phrase is spoken, the maximum value of the rejection and silence DNN node scores accumulate in the S₀ score in each time segment iteration. This is illustrated in top row of FIG. 5. The rejection and silence DNN node score is greater than any of the key phrase DNN node scores and as a result S₀ has the highest score which corresponds to the highest probability state in the HMM model. At this stage S₁ is updated in the propagation operation, so S₁=S₀ after each iteration.

When the first part of the key phrase is processed, at start of phrase 520, S₁ becomes greater than S₀ in the accumulation operation because the DNN node score associated with state 1 is larger. This is illustrated in the second row of FIG. 5. At this point, score propagation from S₀ to S₁ ceases. As additional iterations are performed (e.g., additional time segments of the key phrase are processed), as illustrated in rows 2 through 4, the process repeats. For example, in row 2, for S₁ and S₂: as long as a (sub-)phonetic units corresponding to state 1 is processed, the S₁ score accumulates higher scores than S₂ or S₀ and so the S₁ score propagates on to S₂. Thus, so S₂=S₁ after each iteration. As the key phrase is further processed and a (sub-)phonetic unit corresponding to state 2 is provided, the high scores accumulate in S₂ and score propagation from S₁ to S₂ ceases. This same micro-pattern repeats for S₂ and S₃ and so on, up to S_{N-2} and S_{N-1}, as long as the whole key phrase is being processed (e.g., third and fourth rows of FIG. 5). Finally, at the end of the key phrase 530, either silence or follow on speech is processed, at which point S_{N} accumulates the highest scores and becomes greater than S_{N-1}. The propagation no longer occurs and S_{N}>S_{N-1} (e.g., the bottom row of FIG. 5). A property of the HMM model scoring is that when the key phrase is being processed, the highest scoring state is associated with the DNN node score of the currently processed (sub-)phonetic unit (the states represented by the black filled circles 540 in FIG. 5). Additionally, the accumulation and propagation of high DNN node scores causes the tail of the Markov chain (states to the right of the black filled circles 540) to have descending scores. This pattern is employed by the key phrase segmentation circuit 280 to determine the start and end points 190 of the key phrase.

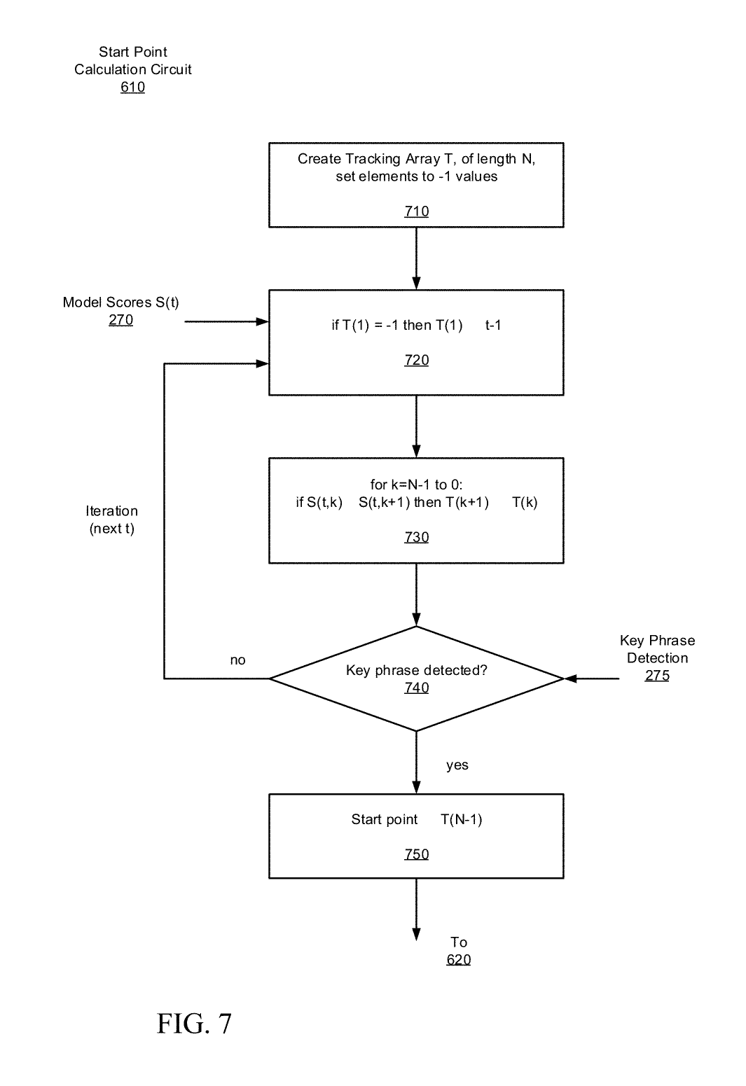

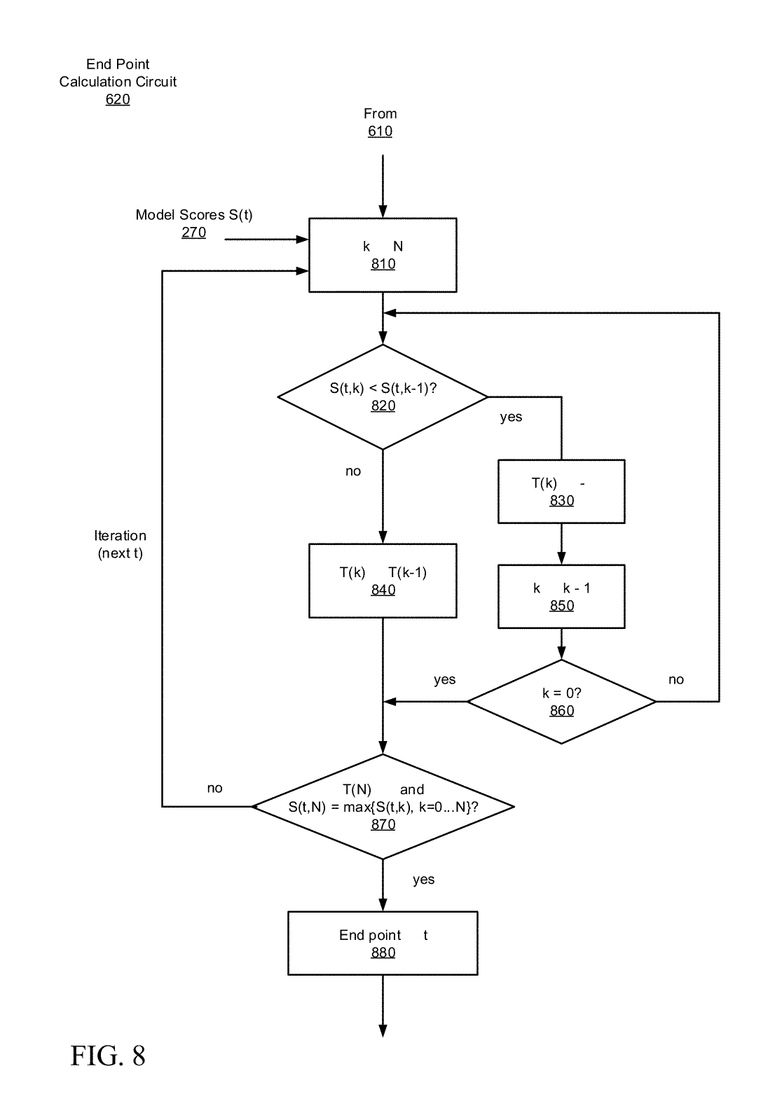

FIG. 6 is a block diagram of the key phrase segmentation circuit 280, configured in accordance with certain embodiments of the present disclosure. The key phrase segmentation circuit 280 is shown to include a start point calculation circuit 610 and an end point calculation circuit 620, configured to generate start and end points 190 based on the model scores 270 and key phrase detection 275 provided by HMM key phrase scoring circuit 260. The operations of the start point calculation circuit 610 and the end point calculation circuit 620 will be described below in connection with FIGS. 7 and 8.

The calculation is an iterative process wherein each iteration is associated with an indexed segment of the input audio signal 110 being processed. A tracking array T of length N is employed to store indices of the segments for aligning of the pattern of scores with the input data. The results of the key phrase segmentation process are: tₛₜₐᵣₜ−the segment index of the key phrase start point, and t_{end}−the segment index of the key phrase end point. During key phrase scoring, but before the detection event, scores are tracked to identify the start of the key phrase.

FIG. 7 is a flow diagram illustrating an implementation of the start point calculation circuit 610, configured in accordance with certain embodiments of the present disclosure. In more detail, at operation 710, a tracking array T of length N is created, and each element of the array is set to a value, for example −1, that indicates the element has not yet been initialized. An iterative process begins at operation 720, where model scores S(t) 270 are provided for the current time segment of the audio signal, which is indexed by the variable t, associated with the current iteration. At operation 720, if the first element of the array T equals −1 (i.e., not yet initialized), then that element is initialized with the currently processed segment index (t−1).

At operation 730, for each pair of consecutive states, if the scores were propagated for those states, then the respective values in the T array are also propagated forward. Only initialized values of the T array are propagated. At operation 740, if the key phrase detection event 275 has not yet occurred, then the iteration continues to operation 720 with the next segment index. Otherwise, at operation 750 the start point is set to the N−1 element of the T array.

These operations can be summarized by the following pseudocode:

| Initialization: | |
|---|---|
| T(k) = −1 for each k | |
| Iteration: | |
| IF T(1)= −1 THEN T(1) ← t − 1 | A1.1 |
| FOR k=N−1 TO 0 DO: | A1.2 |
| IF S(t,k) ≥ S(t,k+ 1) AND T(k) ≥ 0 THEN T(k+1) ← T(k) | |
| In response to detection, tₛₜₐᵣₜ ← T(N−1); break | A1.3 |

As can be seen, T(0) is always equal to −1, therefore, as long as propagations are occurring from S(t, 0) to S(t,1), T(1) is overwritten with −1 in operation A1.2, and re-initialized with a new segment index in the next iteration (operation A1.1).

Once the key phrase processing begins and propagation from S(t, 0) to S(t, 1) ceases, then the overwriting of T(1) stops. The most recent segment index tₛₜₐᵣₜ stored in T(1) starts to propagate forward in the T array as the S(t, 1) score propagates forward in the HMM sequence in the subsequent iterations. Respectively, for k=1 . . . N−1 the propagation T(k)→T(k+1) stops when the (sub-)phonetic unit associated with HMM state k+1 is processed.

When the sequence of (sub-)phonetic units being processed matches the key phrase model and the key phrase detection event occurs, the segment index tₛₜₐᵣₜ is propagated through the tracking array as the state scores S(t,1) . . . S(t,N) are propagated. The tₛₜₐᵣₜ value is not overwritten by the more recent segment indices because the score propagation holds to the pattern described earlier. The tₛₜₐᵣₜ index is associated with the start of the (sub-)phonetic unit sequence matching the key phrase.

At the key phrase detection event, the tₛₜₐᵣₜ index is read from the tracking array T(N−1). This is the estimated start point of the key phrase (operation A1.3).

FIG. 8 is a flow diagram illustrating an implementation of the end point calculation circuit 620, configured in accordance with certain embodiments of the present disclosure. After the detection event has occurred and the start point has been identified, the endpoint calculation begins. An iteration through the state sequence begins at operation 810 with a decreasing index k starting from k=N. At operation 820, as long as S(t,k) is less than S(t,k−1), T(k) is set to −1 at operation 830, k is decremented at operation 850, and at operation 860, if k is not yet equal to zero the process repeats from operation 820 with the decremented k value. Otherwise, if S(t,k) was greater than or equal to S(t,k−1), at operation 820, then T(k−1) is propagated to T(k) at operation 840.

At operation 870, a termination condition is checked. If a nonnegative value has been propagated to T(N) (valid segment indices are always nonnegative) and if S(t,N) is the maximum score in the sequence, then the currently processed segment is determined, at operation 880, to be the endpoint of the phrase.

These operations can be summarized by the following pseudocode:

| | |
|---|---|
| FOR k=N TO 1 DO: | A2.1 |
| IF S(t,k) < S(t,k−1) THEN T(k) ← −1 | |
| ELSE: | |
| T(k−1) → T(k) | |
| BREAK | |
| IF T(N) ≥ 0 AND S(t,N) = max {S(t,k), k=0..N} THEN | A2.2 |
| t_{end} ← t; BREAK | |

After the start point is estimated (operation A1.3), the highest scoring state is typically located after the middle of the phrase (e.g., the third row of FIG. 5) and it is the state corresponding to the currently processed (sub-)phonetic unit. Let m denote the index of this highest scoring state. While the rest of the key phrase is processed, m increases in steps of 1 up to N−1. The T table tracks the currently highest scoring state. This is done in operation A2.1 which ensures that the non-negative segment index propagates forward from T(m) and T(j)=−1 for j>m+1 due to descending scores S(t,m+1), S(t,m+2) S(t,N). When the last (sub-)phonetic unit of the key phrase is being processed (m=N−1), then S(t,N−1) and S(t,N) are the highest scores (maximum probability in the HMM model), so both conditions in A2.2 are met and the index of the currently processed segment is also the estimated end point.

Experimental results show that the second condition of A2.2, that S(t,N) is the maximum score in the sequence, alone provides satisfactory performance. In HMM scoring this condition is fulfilled in most cases when the last (sub-)phonetic unit of the key phrase is processed. Use of the tracking table, however, helps to ensure that the end point is not determined too early (until propagation of scores continues through each state and ends up in S(t,N)). This provides a more robust solution.

### Methodology

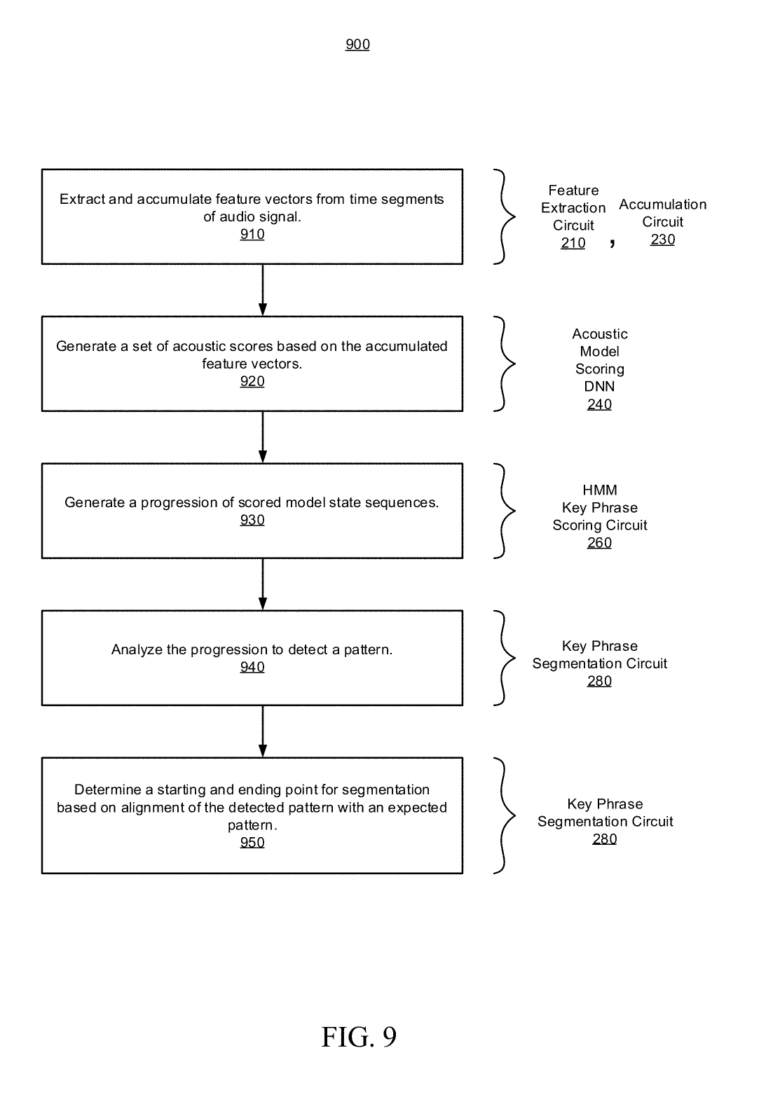

FIG. 9 is a flowchart illustrating an example method 900 for segmentation of a wake on voice key phrase, in accordance with certain embodiments of the present disclosure. As can be seen, the example method includes a number of phases and sub-processes, the sequence of which may vary from one embodiment to another. However, when considered in the aggregate, these phases and sub-processes form a process for key phrase segmentation, in accordance with certain of the embodiments disclosed herein. These embodiments can be implemented, for example, using the system architecture illustrated in FIGS. 1-3, and 6-8, as described above. However other system architectures can be used in other embodiments, as will be apparent in light of this disclosure. To this end, the correlation of the various functions shown in FIG. 9 to the specific components illustrated in the other figures is not intended to imply any structural and/or use limitations. Rather, other embodiments may include, for example, varying degrees of integration wherein multiple functionalities are effectively performed by one system. For example, in an alternative embodiment a single module having decoupled sub-modules can be used to perform all of the functions of method 900. Thus, other embodiments may have fewer or more modules and/or sub-modules depending on the granularity of implementation. In still other embodiments, the methodology depicted can be implemented as a computer program product including one or more non-transitory machine-readable mediums that when executed by one or more processors cause the methodology to be carried out. Numerous variations and alternative configurations will be apparent in light of this disclosure.

As illustrated in FIG. 9, in an embodiment, method 900 for key phrase segmentation commences by accumulating, at operation 910, feature vectors extracted from time segments of an audio signal. In some embodiments, one feature vector may be extracted from each time segment, and 5 to 20 of the most recent consecutive feature vectors may be accumulated, which relate to 50 to 200 milliseconds of audio, to provide a sufficiently wide context as input to the neural network acoustic model.

Next, at operation 920, a neural network is implemented to generate a set of acoustic scores based on the accumulated feature vectors. Each of the acoustic scores in the set represents a probability for a phonetic unit associated with the current time segment of the audio signal. In some embodiments, the neural network is a Deep Neural Network.

At operation 930, a key phrase model decoder is implemented to generate a progression of scored model state sequences. Each of the scored model state sequences is based on detection of (sub-)phonetic units associated with a corresponding one of the sets of the acoustic scores generated from the time segments (prior and current segments) of the audio signal. In some embodiments, the key phrase model decoder is a Hidden Markov Model (HMM) decoder.

At operation 940, the progression of scored state sequences is analyzed to detect a pattern associated with the progression. At operation 950, a starting point and an ending point are determined, for segmentation of the key phrase, based on an alignment of the detected pattern with an expected, predetermined pattern.

Of course, in some embodiments, additional operations may be performed, as previously described in connection with the system. For example, the key phrase may be detected based on an accumulation and propagation of the acoustic scores from the sets of acoustic scores, as previously described, and the determination of the start point may be based on the time segment associated with the detection of the key phrase. In some embodiments, the starting point and the ending point may be provided to one or more of an acoustic beamforming system, an automatic speech recognition system, and a speaker identification system.

### Example System

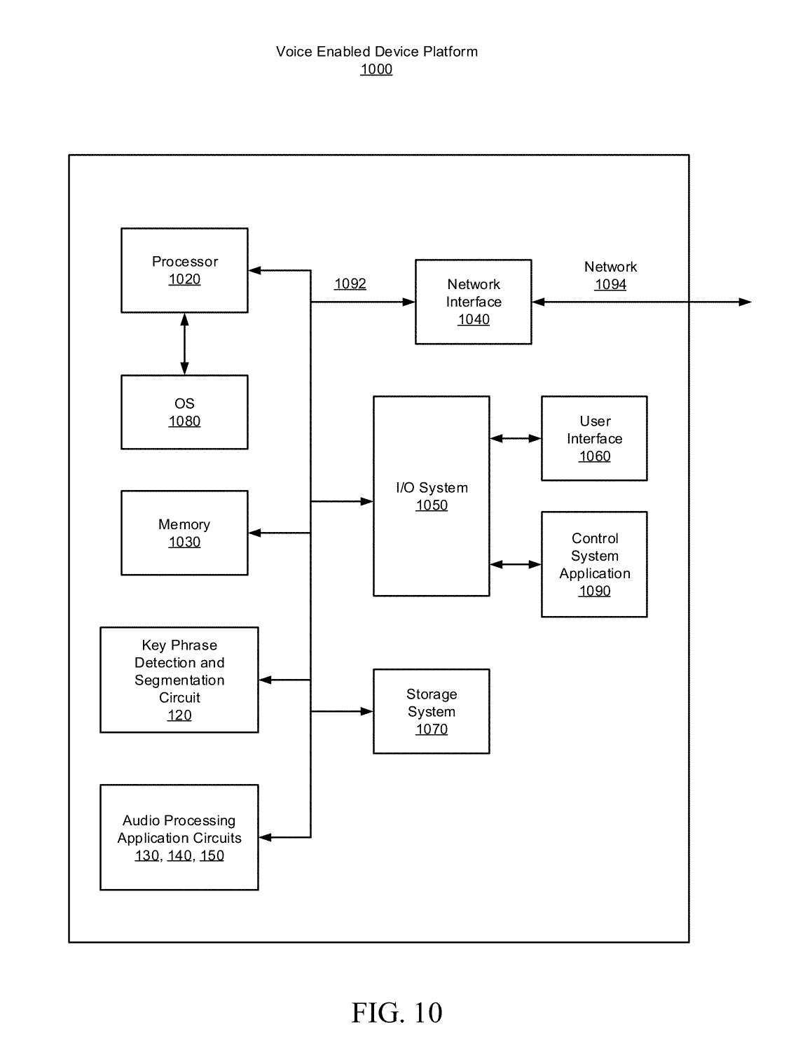

FIG. 10 illustrates an example voice-enabled device platform 1000 to perform key phrase detection in segmentation, configured in accordance with certain embodiments of the present disclosure. In some embodiments, platform 1000 may be hosted on, or otherwise be incorporated into a personal computer, workstation, server system, smart home management system, laptop computer, ultra-laptop computer, tablet, touchpad, portable computer, handheld computer, palmtop computer, personal digital assistant (PDA), cellular telephone, combination cellular telephone and PDA, smart device (for example, smartphone or smart tablet), mobile internet device (MID), messaging device, data communication device, wearable device, embedded system, and so forth. Any combination of different devices may be used in certain embodiments.

In some embodiments, platform 1000 may comprise any combination of a processor 1020, a memory 1030, a key phrase detection and segmentation circuit 120, audio processing application circuits 130, 140, 150, a network interface 1040, an input/output (I/O) system 1050, a user interface 1060, a control system application 1090, and a storage system 1070. As can be further seen, a bus and/or interconnect 1092 is also provided to allow for communication between the various components listed above and/or other components not shown. Platform 1000 can be coupled to a network 1094 through network interface 1040 to allow for communications with other computing devices, platforms, devices to be controlled, or other resources. Other componentry and functionality not reflected in the block diagram of FIG. 10 will be apparent in light of this disclosure, and it will be appreciated that other embodiments are not limited to any particular hardware configuration.

Processor 1020 can be any suitable processor, and may include one or more coprocessors or controllers, such as an audio processor, a graphics processing unit, or hardware accelerator, to assist in control and processing operations associated with platform 1000. In some embodiments, the processor 1020 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core. Processor 1020 may be implemented as a complex instruction set computer (CISC) or a reduced instruction set computer (RISC) processor. In some embodiments, processor 1020 may be configured as an x86 instruction set compatible processor.

Memory 1030 can be implemented using any suitable type of digital storage including, for example, flash memory and/or random-access memory (RAM). In some embodiments, the memory 1030 may include various layers of memory hierarchy and/or memory caches as are known to those of skill in the art. Memory 1030 may be implemented as a volatile memory device such as, but not limited to, a RAM, dynamic RAM (DRAM), or static RAM (SRAM) device. Storage system 1070 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, storage 1070 may comprise technology to increase the storage performance enhanced protection for valuable digital media when multiple hard drives are included.

Processor 1020 may be configured to execute an Operating System (OS) 1080 which may comprise any suitable operating system, such as Google Android (Google Inc., Mountain View, Calif.), Microsoft Windows (Microsoft Corp., Redmond, Wash.), Apple OS X (Apple Inc., Cupertino, Calif.), Linux, or a real-time operating system (RTOS). As will be appreciated in light of this disclosure, the techniques provided herein can be implemented without regard to the particular operating system provided in conjunction with platform 1000, and therefore may also be implemented using any suitable existing or subsequently-developed platform.

Network interface circuit 1040 can be any appropriate network chip or chipset which allows for wired and/or wireless connection between other components of device platform 1000 and/or network 1094, thereby enabling platform 1000 to communicate with other local and/or remote computing systems, servers, cloud-based servers, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 1050 may be configured to interface between various I/O devices and other components of device platform 1000. I/O devices may include, but not be limited to, user interface 1060 and control system application 1090. User interface 1060 may include devices (not shown) such as a microphone (or array of microphones), speaker, display element, touchpad, keyboard, and mouse, etc. I/O system 1050 may include a graphics subsystem configured to perform processing of images for rendering on the display element. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 1020 or any chipset of platform 1000. Control system application 1090 may be configured to perform an action based on a command or request spoken after the wake on voice key phrase, as recognized by ASR circuit 140.

It will be appreciated that in some embodiments, the various components of platform 1000 may be combined or integrated in a system-on-a-chip (SoC) architecture. In some embodiments, the components may be hardware components, firmware components, software components or any suitable combination of hardware, firmware or software.

Key phrase detection and segmentation circuit 120 is configured to detect a wake on voice key phrase spoken by the user and determine a start point and an endpoint to segment that key phrase, as described previously. Key phrase detection and segmentation circuit 120 may include any or all of the circuits/components illustrated in FIGS. 2, 3, and 6-8, as described above. These components can be implemented or otherwise used in conjunction with a variety of suitable software and/or hardware that is coupled to or that otherwise forms a part of platform 1000. These components can additionally or alternatively be implemented or otherwise used in conjunction with user I/O devices that are capable of providing information to, and receiving information and commands from, a user.

In some embodiments, these circuits may be installed local to platform 1000, as shown in the example embodiment of FIG. 10. Alternatively, platform 1000 can be implemented in a client-server arrangement wherein at least some functionality associated with these circuits is provided to platform 1000 using an applet, such as a JavaScript applet, or other downloadable module or set of sub-modules. Such remotely accessible modules or sub-modules can be provisioned in real-time, in response to a request from a client computing system for access to a given server having resources that are of interest to the user of the client computing system. In such embodiments, the server can be local to network 1094 or remotely coupled to network 1094 by one or more other networks and/or communication channels. In some cases, access to resources on a given network or computing system may require credentials such as usernames, passwords, and/or compliance with any other suitable security mechanism.

In various embodiments, platform 1000 may be implemented as a wireless system, a wired system, or a combination of both. When implemented as a wireless system, platform 1000 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, platform 1000 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the key phrase segmentation methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 1094. In other embodiments, the functionalities disclosed herein can be incorporated into other voice-enabled devices and speech-based software applications, such as, for example, automobile control/navigation, smart-home management, entertainment, and robotic applications. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments platform 1000 may comprise additional, fewer, or alternative subcomponents as compared to those included in the example embodiment of FIG. 10.

The aforementioned non-transitory computer readable medium may be any suitable medium for storing digital information, such as a hard drive, a server, a flash memory, and/or random-access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method, process, and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smart phones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

Further Example Embodiments

The following examples pertain to further embodiments, from which numerous permutations and configurations will be apparent.

Example 1 is a method for key phrase segmentation, the method comprising: generating, by a neural network, a set of acoustic scores based on an accumulation of feature vectors, the feature vectors extracted from time segments of an audio signal, each of the acoustic scores in the set representing a probability for a phonetic class associated with the time segments; generating, by a key phrase model decoder, a progression of scored model state sequences, each of the scored model state sequences based on detection of phonetic units associated with a corresponding one of the sets of the acoustic scores generated from the time segments of the audio signal; analyzing, by a key phrase segmentation circuit, the progression of scored state sequences to detect a pattern associated with the progression; and determining, by the key phrase segmentation circuit, a starting point and an ending point for segmentation of a key phrase based on an alignment of the detected pattern with an expected pattern.

Example 2 includes the subject matter of Example 1, further comprising detecting the key phrase based on an accumulation and propagation of the acoustic scores of the sets of the acoustic scores.

Example 3 includes the subject matter of Examples 1 or 2, wherein the determining of the starting point is further based on one of the time segments associated with the detection of the key phrase.

Example 4 includes the subject matter of any of Examples 1-3, wherein the neural network is a Deep Neural Network and the key phrase model decoder is a Hidden Markov Model decoder.

Example 5 includes the subject matter of any of Examples 1-4, wherein the phonetic class is at least one of a phonetic unit, a sub-phonetic unit, a tri-phone state, and a mono-phone state.

Example 6 includes the subject matter of any of Examples 1-5, further comprising providing the starting point and the ending point to at least one of an acoustic beamforming system, an automatic speech recognition system, a speaker identification system, a text dependent speaker identification system, an emotion recognition system, a gender detection system, an age detection system, and a noise estimation system.

Example 7 includes the subject matter of any of Examples 1-6, wherein each of the neural network, key phrase model decoder, and key phrase segmentation circuit is implemented with instructions executing by one or more processors.

Example 8 is a key phrase segmentation system, the system comprising: a feature extraction circuit to extract feature vectors from time segments of an audio signal; an accumulation circuit to accumulate a selected number of the extracted feature vectors; an acoustic model scoring neural network to generate a set of acoustic scores based on the accumulated feature vectors, each of the acoustic scores in the set representing a probability for a phonetic class associated with the time segments; a key phrase model scoring circuit to generate a progression of scored model state sequences, each of the scored model state sequences based on detection of phonetic units associated with a corresponding one of the sets of the acoustic scores generated from the time segments of the audio signal; and a key phrase segmentation circuit to analyze the progression of scored state sequences to detect a pattern associated with the progression, and to determine a starting point and an ending point for segmentation of a key phrase based on an alignment of the detected pattern to an expected pattern.

Example 9 includes the subject matter of Example 8, wherein the key phrase model scoring circuit is further to detect the key phrase based on an accumulation and propagation of the acoustic scores of the sets of the acoustic scores.

Example 10 includes the subject matter of Examples 8 or 9, wherein the determining of the starting point is further based on one of the time segments associated with the detection of the key phrase.

Example 11 includes the subject matter of any of Examples 8-10, wherein the acoustic model scoring neural network is a Deep Neural Network and the key phrase model scoring circuit implements a Hidden Markov Model decoder.

Example 12 includes the subject matter of any of Examples 8-11, wherein the phonetic class is at least one of a phonetic unit, a sub-phonetic unit, a tri-phone state, and a mono-phone state.

Example 13 includes the subject matter of any of Examples 8-12, wherein each of the feature extraction circuit, accumulation circuit, acoustic model scoring neural network, key phrase model scoring circuit, and key phrase segmentation circuit is implemented with instructions executing by one or more processors.

Example 14 is at least one non-transitory computer readable storage medium having instructions encoded thereon that, when executed by one or more processors, cause a process to be carried out for key phrase segmentation, the process comprising: accumulating feature vectors extracted from time segments of an audio signal; generating a set of acoustic scores based on the accumulated feature vectors, each of the acoustic scores in the set representing a probability for a phonetic class associated with the time segments; generating a progression of scored model state sequences, each of the scored model state phonetic units based on detection of phonetic units associated with a corresponding one of the sets of the acoustic scores generated from the time segments of the audio signal; analyzing the progression of scored state sequences to detect a pattern associated with the progression; and determining a starting point and an ending point for segmentation of a key phrase based on an alignment of the detected pattern with an expected pattern.

Example 15 includes the subject matter of Example 14, the process further comprising detecting the key phrase based on an accumulation and propagation of the acoustic scores of the sets of the acoustic scores.

Example 16 includes the subject matter of Examples 14 or 15, wherein the determining of the starting point is further based on one of the time segments associated with the detection of the key phrase.

Example 17 includes the subject matter of any of Examples 14-16, wherein the set of acoustic scores is generated by a Deep Neural Network, and the progression of scored model state sequences is generated using a Hidden Markov Model decoder.

Example 18 includes the subject matter of any of Examples 14-17, wherein the phonetic class is at least one of a phonetic unit, a sub-phonetic unit, a tri-phone state, and a mono-phone state.

Example 19 includes the subject matter of any of Examples 14-18, the process further comprising providing the starting point and the ending point to at least one of an acoustic beamforming system, an automatic speech recognition system, a speaker identification system, a text dependent speaker identification system, an emotion recognition system, a gender detection system, an age detection system, and a noise estimation system.

Example 20 includes the subject matter of any of Examples 14-19, the process further comprising buffering the audio signal and providing the buffered audio signal to the at least one of the acoustic beamforming system, the automatic speech recognition system, the speaker identification system, the text dependent speaker identification system, the emotion recognition system, the gender detection system, the age detection system, and the noise estimation system, wherein the duration of the buffered audio signal is in the range of 2 to 5 seconds.

Example 21 includes the subject matter of any of Examples 14-20, the process further comprising buffering the feature vectors and providing the buffered feature vectors to the at least one of the acoustic beamforming system, the automatic speech recognition system, the speaker identification system, the text dependent speaker identification system, the emotion recognition system, the gender detection system, the age detection system, and the noise estimation system, wherein the buffered feature vectors correspond to a duration of the audio signal in the range of 2 to 5 seconds.

Example 22 is a system for key phrase segmentation, the system comprising: means for generating, by a neural network, a set of acoustic scores based on an accumulation of feature vectors, the feature vectors extracted from time segments of an audio signal, each of the acoustic scores in the set representing a probability for a phonetic class associated with the time segments; means for generating, by a key phrase model decoder, a progression of scored model state sequences, each of the scored model state sequences based on detection of phonetic units associated with a corresponding one of the sets of the acoustic scores generated from the time segments of the audio signal; means for analyzing, by a key phrase segmentation circuit, the progression of scored state sequences to detect a pattern associated with the progression; and means for determining, by the key phrase segmentation circuit, a starting point and an ending point for segmentation of a key phrase based on an alignment of the detected pattern with an expected pattern.

Example 23 includes the subject matter of Example 22, further comprising means for detecting the key phrase based on an accumulation and propagation of the acoustic scores of the sets of the acoustic scores.

Example 24 includes the subject matter of Examples 22 or 23, wherein the determining of the starting point is further based on one of the time segments associated with the detection of the key phrase.

Example 25 includes the subject matter of any of Examples 22-24, wherein the neural network is a Deep Neural Network and the key phrase model decoder is a Hidden Markov Model decoder.

Example 26 includes the subject matter of any of Examples 22-25, wherein the phonetic class is at least one of a phonetic unit, a sub-phonetic unit, a tri-phone state, and a mono-phone state.

Example 27 includes the subject matter of any of Examples 22-26, further comprising means for providing the starting point and the ending point to at least one of an acoustic beamforming system, an automatic speech recognition system, a speaker identification system, a text dependent speaker identification system, an emotion recognition system, a gender detection system, an age detection system, and a noise estimation system.

Example 28 includes the subject matter of any of Examples 22-27, wherein each of the neural network, key phrase model decoder, and key phrase segmentation circuit is implemented with instructions executing by one or more processors.

Example 29 includes the subject matter of any of Examples 22-28, further comprising means for buffering the audio signal and providing the buffered audio signal to the at least one of the acoustic beamforming system, the automatic speech recognition system, the speaker identification system, the text dependent speaker identification system, the emotion recognition system, the gender detection system, the age detection system, and the noise estimation system, wherein the duration of the buffered audio signal is in the range of 2 to 5 seconds.

Example 30 includes the subject matter of any of Examples 22-29, further comprising means for buffering the feature vectors and providing the buffered feature vectors to the at least one of the acoustic beamforming system, the automatic speech recognition system, the speaker identification system, the text dependent speaker identification system, the emotion recognition system, the gender detection system, the age detection system, and the noise estimation system, wherein the buffered feature vectors correspond to a duration of the audio signal in the range of 2 to 5 seconds.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner, and may generally include any set of one or more elements as variously disclosed or otherwise demonstrated herein.

What is claimed is:

1. A method for key phrase segmentation, the method comprising:
generating, by a neural network, a set of acoustic scores based on an accumulation of feature vectors, the feature vectors extracted from time segments of an audio signal, each of the acoustic scores in the set representing a probability for a phonetic class associated with the time segments;
generating, by a key phrase model decoder, a progression of scored model state sequences, each of the scored model state sequences based on detection of phonetic units associated with a corresponding one of the sets of the acoustic scores generated from the time segments of the audio signal;
analyzing, by a key phrase segmentation circuit, the progression of scored state sequences to detect a pattern associated with the progression; and
determining, by the key phrase segmentation circuit, a starting point and an ending point for segmentation of a key phrase based on an alignment of the detected pattern with an expected pattern.

2. The method of claim 1, further comprising detecting the key phrase based on an accumulation and propagation of the acoustic scores of the sets of the acoustic scores.

3. The method of claim 2, wherein the determining of the starting point is further based on one of the time segments associated with the detection of the key phrase.

4. The method of claim 1, wherein the neural network is a Deep Neural Network and the key phrase model decoder is a Hidden Markov Model decoder.

5. The method of claim 1, wherein the phonetic class is at least one of a phonetic unit, a sub-phonetic unit, a tri-phone state, and a mono-phone state.

6. The method of claim 1, further comprising providing the starting point and the ending point to at least one of an acoustic beamforming system, an automatic speech recognition system, a speaker identification system, a text dependent speaker identification system, an emotion recognition system, a gender detection system, an age detection system, and a noise estimation system.

7. The method of claim 1, wherein each of the neural network, key phrase model decoder, and key phrase segmentation circuit is implemented with instructions executing by one or more processors.

8. A key phrase segmentation system, the system comprising:
a feature extraction circuit to extract feature vectors from time segments of an audio signal;
an accumulation circuit to accumulate a selected number of the extracted feature vectors;
an acoustic model scoring neural network to generate a set of acoustic scores based on the accumulated feature vectors, each of the acoustic scores in the set representing a probability for a phonetic class associated with the time segments;
a key phrase model scoring circuit to generate a progression of scored model state sequences, each of the scored model state sequences based on detection of phonetic units associated with a corresponding one of the sets of the acoustic scores generated from the time segments of the audio signal; and
a key phrase segmentation circuit to analyze the progression of scored state sequences to detect a pattern associated with the progression, and to determine a starting point and an ending point for segmentation of a key phrase based on an alignment of the detected pattern to an expected pattern.

9. The system of claim 8, wherein the key phrase model scoring circuit is further to detect the key phrase based on an accumulation and propagation of the acoustic scores of the sets of the acoustic scores.

10. The system of claim 9, wherein the determining of the starting point is further based on one of the time segments associated with the detection of the key phrase.

11. The system of claim 10, wherein the acoustic model scoring neural network is a Deep Neural Network and the key phrase model scoring circuit implements a Hidden Markov Model decoder.

12. The system of claim 8, wherein the phonetic class is at least one of a phonetic unit, a sub-phonetic unit, a tri-phone state, and a mono-phone state.

13. The system of claim 8, wherein each of the feature extraction circuit, accumulation circuit, acoustic model scoring neural network, key phrase model scoring circuit, and key phrase segmentation circuit is implemented with instructions executing by one or more processors.

14. At least one non-transitory computer readable storage medium having instructions encoded thereon that, when executed by one or more processors, cause a process to be carried out for key phrase segmentation, the process comprising:
accumulating feature vectors extracted from time segments of an audio signal;
generating a set of acoustic scores based on the accumulated feature vectors, each of the acoustic scores in the set representing a probability for a phonetic class associated with the time segments;
generating a progression of scored model state sequences, each of the scored model state phonetic units based on detection of phonetic units associated with a corresponding one of the sets of the acoustic scores generated from the time segments of the audio signal;
analyzing the progression of scored state sequences to detect a pattern associated with the progression; and
determining a starting point and an ending point for segmentation of a key phrase based on an alignment of the detected pattern with an expected pattern.

15. The computer readable storage medium of claim 14, the process further comprising detecting the key phrase based on an accumulation and propagation of the acoustic scores of the sets of the acoustic scores.

16. The computer readable storage medium of claim 15, wherein the determining of the starting point is further based on one of the time segments associated with the detection of the key phrase.

17. The computer readable storage medium of claim 14, wherein the set of acoustic scores is generated by a Deep Neural Network, and the progression of scored model state sequences is generated using a Hidden Markov Model decoder.

18. The computer readable storage medium of claim 14, wherein the phonetic class is at least one of a phonetic unit, a sub-phonetic unit, a tri-phone state, and a mono-phone state.

19. The computer readable storage medium of claim 14, the process further comprising providing the starting point and the ending point to at least one of an acoustic beamforming system, an automatic speech recognition system, a speaker identification system, a text dependent speaker identification system, an emotion recognition system, a gender detection system, an age detection system, and a noise estimation system.

20. The computer readable storage medium of claim 19, the process further comprising buffering the audio signal and providing the buffered audio signal to the at least one of the acoustic beamforming system, the automatic speech recognition system, the speaker identification system, the text dependent speaker identification system, the emotion recognition system, the gender detection system, the age detection system, and the noise estimation system, wherein the duration of the buffered audio signal is in the range of 2 to 5 seconds.

21. The computer readable storage medium of claim 19, the process further comprising buffering the feature vectors and providing the buffered feature vectors to the at least one of the acoustic beamforming system, the automatic speech recognition system, the speaker identification system, the text dependent speaker identification system, the emotion recognition system, the gender detection system, the age detection system, and the noise estimation system, wherein the buffered feature vectors correspond to a duration of the audio signal in the range of 2 to 5 seconds.
